(19) United States
(12) Patent Application Publication
(10) Pub. No.: US 2006/0176401 A1
(43) Pub. Date: Aug. 10, 2006

(54) Imaging device

(76) Inventor: Renato Andrea Danilo Turchetta, Abingdon (GB)

Correspondence Address: BIRCH STEWART KOLASCH & BIRCH, PO BOX 747, FALLS CHURCH, VA, 22040-0747, US

(21) Appl. No.: 10/532,425

(22) PCT Filed: Oct. 24, 2003
(86) PCT No.: PCT/GB03/04613

§ 371 Date: Apr. 22, 2005

(30) Foreign Application Priority Data
Oct. 24, 2002 (GB) 0224770.8

(51) Int. Cl. H04N 5/14

(52) U.S. Cl. 348/571

(57) ABSTRACT

An imaging device comprising a two-dimensional array of pixels which are scanned to build up a desired image. Each pixel comprises a sensor such as a photodiode PD which outputs a signal dependent upon the strength of the incident radiation. This signal is amplified in an inverter circuit MB1, MIN and switched by transistors MW1, MW2 which in turn are controlled by a write signal applied to their connected gate electrodes. During the write period, the output signal from photodiode PD is passed to a line (4) which is input to a number n+1 of memory cells MO to Mn which are switched sequentially via respective control inputs sample to sample to receive and store respective samples of the amplified signal from photodiode PD. The stored samples are read out sequentially over a read period during which a read transistor MSE, controlled by a read signal at its gate electrode, connects the memory cells to an output terminal (3) connected to the column bus.

This invention relates to an imaging device, in particular to an imaging device comprising an array of pixels fabricated using a microelectronic technology such as CMOS.

There are a number of types of imaging devices including charge coupled devices (CCD), photodiodes, and charge injection devices. CCD's in particular have a number of advantages which make them particularly suitable for imaging devices. CCD's work by storing the charge generated by radiation on the imaging device and then transferring the charge to an output stage, located on the periphery of the silicon substrate. Although CCD's provide good image quality, they are limited in the amount of processing they can perform and their performance falls off at high speed due to the inherently serial process and the need for a high bandwidth output stage. In addition, the standard CCD is incompatible with CMOS processing which means that it is difficult to fabricate on-chip electronics for processing the CCD signals.

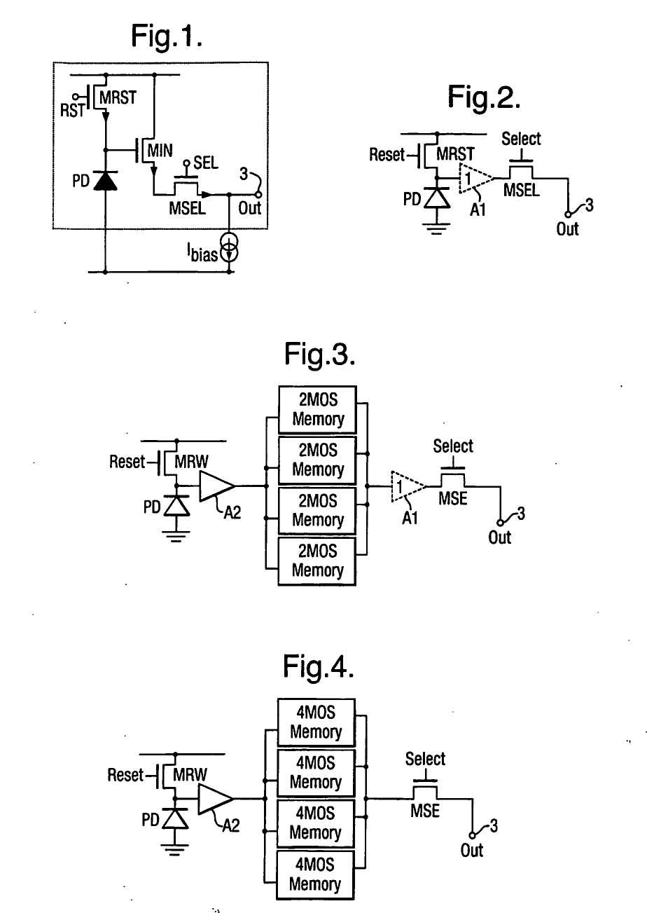

In the early 1990's a new architecture was developed which is fully compatible with CMOS. This is known as active pixel sensor (APS) architecture and is described, for example, in U.S. Pat. No. 5,471,515. The basic APS architecture is shown in FIG. 1 of the accompanying drawings, and can be fully fabricated in CMOS.

FIG. 1 shows the circuitry associated with a single pixel 1 of a pixel array forming part of an imaging device suitable for imaging electromagnetic radiation. Each pixel comprises a sensor, such as a photodiode or photogate (a photodiode PD is illustrated) together with a small number of MOS transistors for processing the signal output from the sensor. Typically, these comprise a reset transistor MRST connected in series with the photodiode PD between the supply lines, a source follower transistor MIN which receives at its gate electrode the output of the photodiode PD, and a pixel select transistor MSEL which receives the output from the source follower transistor MIN, and selectively passes it to an output terminal 3 which is connected to a column bus (not shown). A current source I_{bias}, located outside the pixel, provides operating current for the source follower.

The reset transistor MRST is used to reset the photodiode PD to the positive supply voltage or to other, user-controlled, positive voltage. Following a reset, radiation incident on the photodiode PD results in a corresponding reduction in potential at the gate of the source follower transistor MIN in accordance with the strength of the radiation. All of the outputs of the pixels in a column are connected to a common column bus, but only one pixel at a time is selected in each column, using the switching action of the pixel select transistor MSEL which receives a switching signal at terminal SEL which is passed to its gate to switch the transistor on and off. Switching is controlled in such a way that all of the pixels in each row of the array are read out simultaneously in parallel, the signals from each pixel being passed to a respective column bus for passage to external circuitry (not shown) which carries out the signal processing.

The ability of the APS architecture to utilise standard CMOS electronics brings a certain number of advantages over use of CCD's. These include lower power requirements, improved radiation resistance, improved speed (because the readout operation Is in parallel, the bandwidth of the amplifiers can be limited, thus limiting noise), and the ability to randomly access selected pixels.

However, the standard APS architecture has its own limitations:

1) Speed: a full image has to be read out before the following one is taken. The readout speed is mainly limited by the fact that the OUT line needs to be charged to the corrected voltage. Sensors with full frame capability in the order of 500 frames per second have already been designed, but these rates start to hit intrinsic limits. Alternative architecture integrates the use of any analogue to digital converter (ADC) in each pixel. These have an effective limit in the range of 1000 fps, since it is very difficult (if not impossible) to integrate fast ADCs in a pixel. It is also possible to increase the speed by sub-sampling the image, thus reducing the number of pixels to be read. However this has the disadvantage of reducing the resolution of the device. Any attempt to increase the speed of standard APS will eventually hit the physical limit imposed by the relatively high capacitance of the output bus running for the entire length of the array.

2) Dynamic range: kTC (or reset) noise is the dominant source of noise. This sets a detection limit on small signals. On high signals, the limit is given by the full well capacity. Multiple sampling methods have also been used to enhance sensitivity.

The present invention seeks to address these limitations.

According to the invention there is provided an imaging device comprising an array of pixels in which, for each pixel, there is provided:

a sensor which is sensitive to a variable quantity to be imaged and for outputting a signal representative of the variation in said quantity during an integration period;

amplifier means for amplifying the signal from said sensor,

a plurality of memory cells for holding sequential samples of the amplified signal from the sensor during the integration period; and

read switch means actuable to enable the contents of said memory cells to be read out.

Generally speaking, the circuitry associated with each pixel will comprise at least the sensor, an amplifier means in the form of a buffer amplifier and the read switch means. However, in the preferred embodiment, all of the components—sensor, amplifier means, memory cells and read switch means will be contained within the circuitry associated with each pixel, said components being fabricated together using CMOS or equivalent techniques.

The quantity to be imaged may be any quantity which may be imaged and is susceptible to being measured by a sensor to produce a signal representative of the variation in the quantity. Examples are radiation, particularly electromagnetic radiation, including charged particle radiation and neutron radiation, and electric potentials or time variation of electric potentials.

The sensor may be any device suitable to provide an output which is sensitive to the variable quantity to be imaged. A common application will be in the detection of electromagnetic radiation, both visible and non-visible (for example in the infrared or ultraviolet domain). The use of a converter layer put in front of the sensor will also improve its efficiency in detecting shorter wavelengths, like X- or gamma-rays, as well as neutrons. The sensor could also be made so that it is highly, possibly fully, efficient to charged particles. Static or dynamic electric potentials could also be imaged. For the sake of simplicity, it will be assumed herein that the radiation to be detected is visible light and, for this purpose, a photodiode or phototransistor is suitable.

The amplifier means is necessary to buffer the output of the sensor and may for example be a source follower, an inverter, a voltage buffer or a charge amplifier. A source follower has a gain of one or less than one, and references herein to amplifier and amplification should be understood in this context. An inverter, whilst slightly more complex, has the ability to provide a positive gain, say up to about 10. Preferably the timing is such that the amplifier means is continuously energised during the integration period, or at least a part thereof. This allows every pixel in a particular column to simultaneously write into the memory cells.

In their simplest form, each memory cell comprises a selection means, and a storage means. The selection means may be realised by a MOS transistor whose gate has a switching signal applied to it from a timing circuit controlled by the system clock. The storage means may be realised by a capacitor or by an alternative component, such as another MOS transistor, acting as a capacitor.

The timing circuit is common to all of the memory cells and, indeed, to all of the memory cells in all of the pixels and, as such, will be separate from the array (although, of course, it may be fabricated on the same substrate). The timing circuit applies successive switching pulses to successive memory cells during the integration period so that each memory cell contains a respective sample representative of the instantaneous value of the amplified signal from the sensor at the moment when the sample is taken. Each memory cell takes a single sample in each integration period and the maximum number of samples which can be taken during each integration period is thus equal to the number of memory cells. Generally, the timing is arranged so that the samples—however many there are—are taken at evenly spaced time intervals throughout the integration period; however, other patterns of timing within the integration period may be preferred in order to cater for particular circumstances.

Preferably means are provided for switching between the write mode of the pixel circuitry, corresponding to the integration period, and the read mode of the pixel circuitry during which the contents of the memory cells are read out and passed via the respective column bus for that pixel to external processing circuitry. In an embodiment, this write/read switching means includes a write switch means situated in the signal path between the sensor and the memory cells. Preferably the write switch means is downstream of the amplifier means so that the sensor output is buffered.

The timing circuit also supplies a write-read switching signal to the write/read switching means so as to switch the pixel circuitry from write mode to read mode and vice versa. During the integration period the pixel circuitry is in write mode and, at the end of the integration period, the circuitry is switched to read mode to enable the contents of the memory cells to be read out, as aforesaid.

The read switch means is connected between the memory cells and the output of the individual pixel circuitry, which latter is connected to the respective column bus for that pixel. The read switch means is a component of the write/read switching means discussed above, and works in conjunction with the write switch means to control the operation of the circuit. A buffer amplifier is preferably placed between the output of the memory cells and the read switch means. This amplifier may, for example, comprise a MOS transistor connected as a source follower, and this means that the readout operation, as far as the external circuitry is concerned, is similar to that of a standard APS circuit (c.f. FIG. 1). However, a charge amplifier might be a better solution, particularly where a twin MOS memory cell (as discussed above) is used.

The readout operation is timed to take place between successive write operations (but see below as to the possibility of interleaving the write and read operations). The individual memory cells are read out successively in turn in a similar manner to the write operation. Generally speaking the memory cells are written to and read from one at a time; however it is possible to perform each write operation to a group of memory cells comprising multiple memory cells and this would result in the storage of the same voltage in all memory cells of the group. This would, of course, reduce the effective number of memory cells—for example, if there were 10 memory cells in total, and two memory cells in each group, then the effective number of memory cells would be 5. However, simultaneous writing to multiple memory cells might have advantage in improving such things as noise performance and redundancy. Likewise, it is possible to read from multiple memory cells simultaneously. For example, the memory cells comprised within the aforesaid groups may be read simultaneously for similar reasons to those given above. It is also possible to simultaneously read multiple memory cells which have not been written to together, and these do not (necessarily) store the same voltage. Simultaneous reading of two or more cells, whether the stored voltage be the same or different will result in the sum of the charge stored in the memory cells concerned. The output from each memory cell, or from a summing operation as just described, is passed via said read switch means to the column bus for processing with the output from other pixels in external processing circuitry.

The circuitry associated with each pixel preferably further includes reset means for resetting the circuitry at appropriate times, in particular in between the write and read operations. In the preferred embodiments, two resets are provided: a write reset for resetting the output of the sensors preparatory to the commencement of the integration period and a read reset for resetting the output of the memory cells between each read operation. In both cases, the relevant circuitry can be realised by a switching transistor such as a MOS transistor whose gate is connected to receive a write reset signal or a read reset signal, as appropriate, to apply a reference voltage to reset the circuitry. Preferably, both of the reset signals are output from the aforementioned timing circuit.

Up to now, it has been assumed that the read and write operations will occur separately and successively—i.e. a first write operation corresponding to an integration period, followed by a first read operation during which the values stored as a result of the first write operation are read out, followed again by a second write operation covering a subsequent integration period and a second read operation, and so on. However, the timing circuit can be adjusted to enable the write operations and read operations to be time interleaved with one another so that the read and write operations are, in effect, carried out in the same time frame, although not simultaneously. Such interleaving has the potential to speed up operation of the pixel circuitry still further.

In order that the invention may be better understood, several embodiments will now be described by way of example only and with reference to the accompanying drawings in which:—

FIGS. 1 and 2 are circuit diagrams of a known pixel circuit utilising APS architecture;

FIGS. 3 and 4 are circuit diagrams similar to FIG. 2, but showing two different embodiments of the present invention;

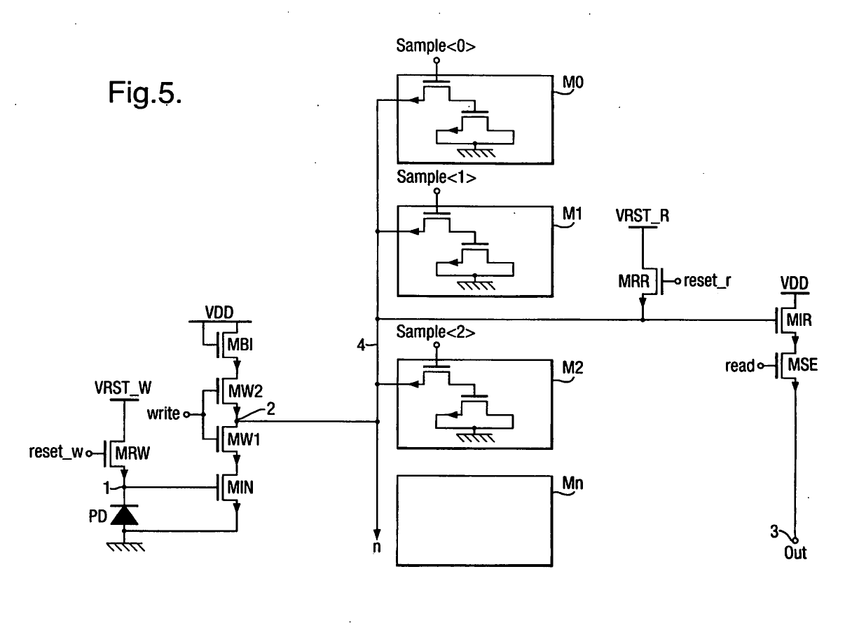

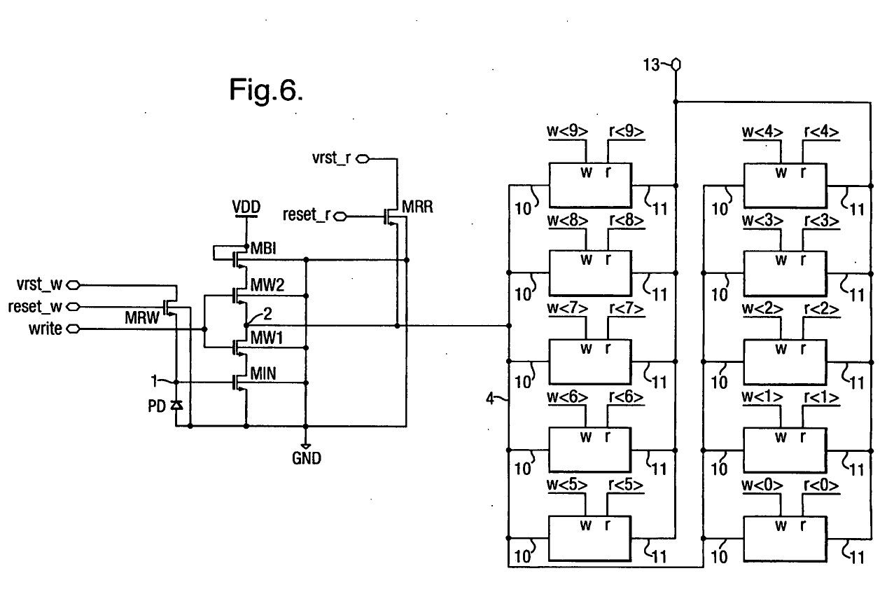

FIGS. 5 and 6 are detailed circuit diagrams of the embodiments of FIGS. 3 and 4 respectively;

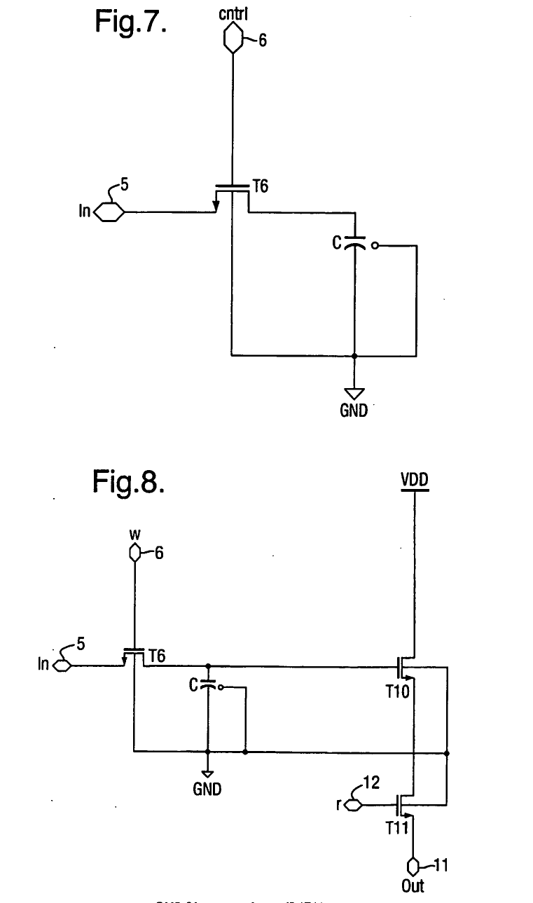

FIGS. 7 and 8 are circuit diagrams of the memory cell used in the embodiments of FIGS. 3 and 4 respectively;

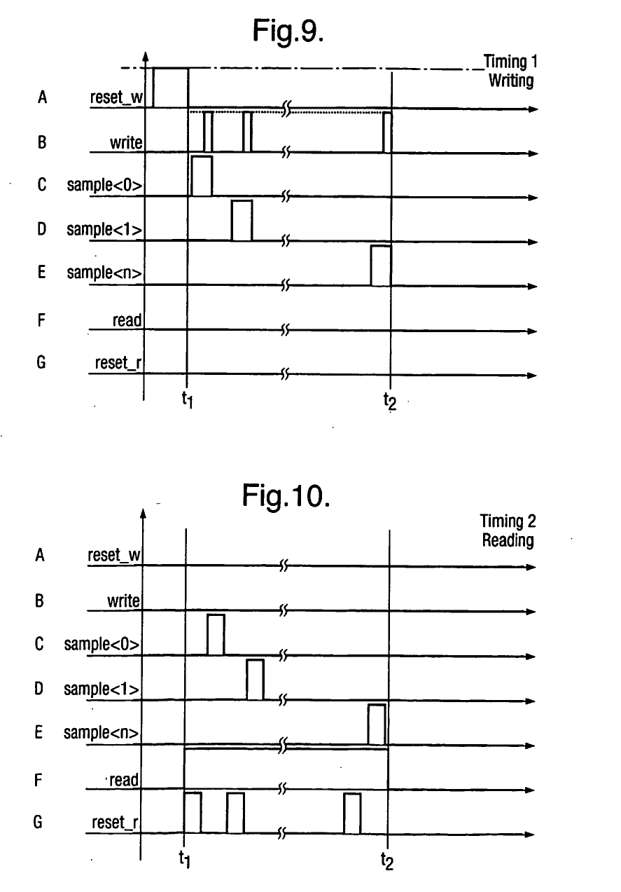

FIGS. 9 and 10 are multiple waveform diagrams to illustrate the operation of the circuit of FIG. 5; and

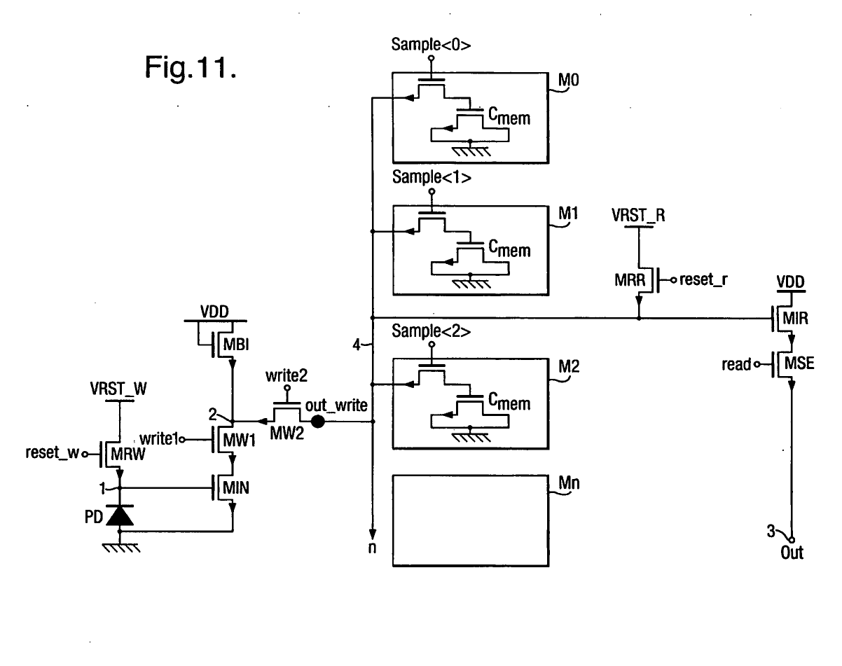

FIGS. 11 to 15 are circuit diagrams showing modified versions of the embodiment of FIG. 5.

The image device of the invention comprises a two-dimensional, usually planar, array of pixels which are scanned in turn to build up the desired image. The technique of scanning Is well known and will not be described in detail; suffice to say that the output from each pixel is selected in turn to build up an electronic representation of the image. This invention is concerned particularly with the composition of each pixel.

FIG. 2 is a simplified version of FIG. 1, redrawn to be more directly comparable with FIGS. 3 and 4, to be described below. The source follower MIN is represented as amplifier A1 having a gain of 1. The amplifier A1 is greyed to represent the fact that only one pixel in a column can work at any one time.

Referring to FIG. 3, there is shown a first embodiment of the present invention. This embodiment differs from the prior art in that, between the photodiode PD and the amplifier A1 there are a plurality of memory cells 1 to 4, each of which stores a respective discrete sample of the signal from the sensor, as will be explained in more detail below. Between the photodiode PD and the memory cells 1 to 4 is an amplifier A2 which may, for example, be a source follower, or an inverter. As before, the amplifier A1 is greyed to represent the fact that only one pixel in a column can work at any one time. By contrast, the amplifier A2 is continuously biased during the integration period, independent of the other pixels.

FIG. 5 shows the circuit of FIG. 3 in greater detail. All of the transistors are N-channel MOS (NMOS) transistors. The photodiode PD may be of any type available in the microelectronics industry. The nwell/psub type can give 100% fill factor (i.e. the ratio between the area sensitive to the radiation and the total area), this characteristic being particularly desirable for the detection of charged particles. For detection of visible light, alternative types, for example nplus/pwell, may give better performance because of reduced diffusion and hence better timing properties.

The reset transistor MRW is connected in series with the photodiode PD between a reference supply voltage vrst_w and ground. Thus the voltage at the junction 1 of the source of transistor MRW and the diode is representative of the instantaneous radiation incident upon the diode. The gate of transistor MRW is connected to a reset write voltage reset_w. A positive pulse at the gate causes the transistor MRW to switch ON, thus applying the write reference voltage vrst_w to the junction 1.

The junction 1 is connected to a conventional inverter circuit comprising series connected amplifier transistors MB1, MIN connected between a supply rail V_{dd} and ground The inverter circuit is modified in that a pair of series-connected switching transistors MW1, MW2 are connected between the source of transistor MB1 and the drain of transistor MIN. The gates of transistors MW1 and MW2 are connected together to receive a write signal. If the write signal goes positive, the transistors MW1 and MW2 will be switched ON and will thus energise the inverter circuit. The output from the inverter circuit is taken from a junction 2 between the source of transistor MW2 and the drain of transistor MW1.

The junction 2 is connected to a number n+1 memory cells M0 to Mn via a line 4 which is common to all of the cells. As will be explained below, each memory cell comprises a switch means and a storage means. The switch means is switched ON by a control signal applied to a respective connection sample <0> to sample <n>. The control signals are generated by a timing circuit (not shown).

The junction 2 is further connected to the input of an output stage comprising source follower transistor MIR whose output is connected, via a pixel select transistor MSE to an output terminal 3. Other types of output stage can be used, such as a charge amplifier or voltage buffer, which may be preferable in certain circumstances. The output terminal 3 is connected to a column bus (not shown) in common with the other pixels in the same column in the array. As will be explained in more detail below, reading is effected by applying a read signal to the gate of transistor MSE which switches the transistor ON to connect the output of the source follower transistor MIR to the column bus via the output terminal 3.

A read reset transistor MRR is connected from the gate of transistor MIR to a read reference supply vrst_r. The transistor MRR is switched on by the application of a suitable voltage reset_r at its gate to apply the read reference potential vrst_r to the gate of transistor MIR, to reset the circuit for the read operation, as will be explained in more detail below.

In common with the control signals applied to the memory cells M0 to Mn, the reset signals and the write and read signals discussed above are all generated by the timing circuit, as will be explained. Furthermore, it will be noted that the substrates of all of the transistors are connected in common to ground, as is the usual CMOS practice.

The operation of the circuit of FIG. 5 will now be explained in more detail, with additional reference to the timing diagrams in FIGS. 9 and 10.

The period during which data collected by the photodiode PD is passed to the remainder of the pixel circuitry is generally referred to as the integration period. This period is controlled by the write signal (FIG. 9B) applied to the gate of transistors MW1 and MW2. The write signal may be applied as a single pulse (the outline of which is shown dotted in FIG. 9) covering the whole of the integration period, or a series of pulses (as shown solid in FIG. 9). When the write signal is positive, the transistors MW1 and MW2 are switched ON which supplies operating current to the inverter transistors MB1 and MIN, and signals from the junction 1 are passed through to the output 2 of the inverter with a modest gain, typically about 2. The integration period is thus the period t₁ to t₂ during which the transistors MW1 and MW2 are switched ON, either continuously or discontinuously, by the write signal. This is in contrast to the prior art arrangement illustrated in FIG. 1 in which the energisation of the amplifier following the photodiode (source follower MIN) is controlled by the state of the pixel select transistor MSEL, and only needs to happen during the readout of the sensor, not during the integration period.

Immediately prior to the commencement of the integration period a write reset pulse signal reset_w (FIG. 9A) is applied to the gate of transistor MRW to switch the transistor ON and apply a write reference voltage vrst_w to the junction 1. This resets (biasses) the photodiode PD to a high positive potential (vrst_w), and thus acts as a fixed “baseline” at the commencement of the integration period. The pulse duration is typically about 1 μs.

During the integration period the voltage at junction 1 changes from the reference voltage vrst_w at its commencement in accordance with the strength of the radiation incident on the sensitive area of the photodiode PD. These changes are amplified by the inverter (MB1, MIN), as already discussed, and appear at the inverter output 2 and hence on the line 4. The transistors MIR, MRR and MSE are switched OFF, but control signals sample <0> to sample <n> are passed to the memory cells M0 to Mn respectively to connect the common line 4 through to a storage means within each memory cell. As already discussed, the timing of the control signals sample <0> to sample <n> can be arranged in various ways, but the most straightforward way is that, for the duration of the integration period, control signals will be applied successively, and one at a time, to the memory cells M0 to Mn, so that each memory cell stores in its storage means a respective sample of the amplified signal from junction 1. This is clarified in FIG. 9 where it will be seen that waveform C corresponds to control signal sample <0>, waveform D corresponds to control signal sample <1>, and so on. It will be seen that the control signals are evenly spaced throughout the duration of the integration period, and are in synchronism with respective pulses of the write signal, so that the corresponding samples stored within the memory cells M0 to Mn are likewise evenly spaced throughout the integration period.

It will be understood by those skilled in the art that such samples, provided that they are taken sufficiently frequently, can accurately reproduce variations in the signal from the photodiode when processed by suitable circuitry. The number of samples taken—and hence their frequency—depends on the number of memory cells. For example, if just 10 memory cells are used, this means that a maximum of 10 samples can be taken during the integration period. In order to integrate all of the memory cells in a single pixel requires a compromise with the noise performance of the pixel and current technology will limit the number of memory cells on, say, a 50×50 micron pixel to about 100. However, advances in technology will see this limit rise over the coming years.

Sampling frequencies typically of between 1 and 10 MHz are currently possible but these are set to increase as CMOS technology evolves.

Clearly also the number of memory cells, and hence the number of samples within each integration period, depends on the size of the individual pixels, as well as on the required signal and noise performances. In the 10 memory cell version illustrated in the drawings, each storage capacitor is 3.5×3.5 μm in size. This size was chosen to achieve a noise performance better than about 50 e⁻rms (electron root mean square). Table 1 gives an estimate of pixel area with current 0.25 μm technology. With this same capacitor size, about 100 memory cells can be integrated in a 50×50 micron pixel. Table 2 gives an estimate of pixel area for a projected future technology of 0.035 micron.

TABLE 1
Existing technology (0.25 micron)

| MOScap | | | 10-cell | | | | |
|---|---|---|---|---|---|---|---|
| size | Store cap | Cell size | pixel | Cells/20 μm | Cells/50 μm | 100-cell | 1000-cell |
| μm | fF | μm\hat{ }2 | μm | pixel | pixel | pixel | pixel |
| 1 | 6.3 | 11.3 | 12.3 | 32 | 218 | 34.1 | 106.3 |
| 2 | 25.0 | 19.3 | 15.2 | 18 | 127 | 44.3 | 138.9 |
| 3 | 56.3 | 29.3 | 18.2 | 12 | 84 | 54.5 | 171.1 |
| 4 | 100.0 | 41.3 | 21.3 | 8 | 59 | 64.5 | 203.2 |
| 5 | 156.3 | 55.3 | 24.3 | 6 | 44 | 74.6 | 235.1 |
| 6 | 225.0 | 71.3 | 27.4 | 5 | 34 | 84.6 | 267.0 |
| 7 | 306.3 | 89.3 | 30.5 | 4 | 27 | 94.7 | 298.8 |
| 8 | 400.0 | 109.3 | 33.7 | 3 | 22 | 104.7 | 330.6 |
| 9 | 506.3 | 131.3 | 36.8 | 2 | 18 | 114.7 | 362.3 |

TABLE 2
Future technology (0.035 micron)

| MOScap | | | 10-cell | | | | |
|---|---|---|---|---|---|---|---|
| size | Store cap | Cell size | pixel | Cells/20 μm | Cells/50 μm | 100-cell | 1000-cell |
| μm | fF | μm\hat{ }2 | μm | pixel | pixel | pixel | pixel |
| 1 | 62.5 | 1.6 | 7.5 | 231 | 1584 | 14.0 | 39.9 |
| 2 | 250.0 | 5.1 | 9.5 | 71 | 486 | 23.4 | 71.4 |
| 3 | 562.5 | 10.6 | 12.1 | 34 | 233 | 33.1 | 102.9 |
| 4 | 1000.0 | 18.1 | 14.9 | 19 | 136 | 43.0 | 134.5 |
| 5 | 1562.5 | 27.6 | 17.8 | 13 | 89 | 52.9 | 166.1 |
| 6 | 2250.0 | 39.1 | 20.7 | 9 | 62 | 62.8 | 197.7 |
| 7 | 3062.5 | 52.6 | 23.8 | 6 | 46 | 72.8 | 229.3 |
| 8 | 4000.0 | 68.1 | 26.8 | 5 | 36 | 82.7 | 260.9 |
| 9 | 5062.5 | 85.6 | 29.9 | 4 | 28 | 92.7 | 292.6 |

At the end of the integration period the write signal switches OFF the transistors MW1 and MW2 and de-energises the inverter MB1, MIN. It is now possible to read out the contents of the memory cells and pass them to the column bus via the output terminal 3. To achieve this a read signal (FIG. 10F) is applied to the gate of the pixel select transistor MSE which switches the transistor ON and energises the source follower transistor MIR. Current for this purpose may be obtained from a common current source, such as shown in FIG. 1.

During the read period t₃ to t₄ control signals samples <0> (FIG. 10C) to sample <n> (FIG. 10E) are applied to the memory cells to sequentially read out the values stored in the respective storage means within each memory cell M0 to Mn. Immediately preceding each read operation, a reset signal reset_r (FIG. 10G) is applied to the gate of transistor MRR which applies a read reference voltage vrst_r to the gate of the source follower transistor MIR.

The timing of the readout operation can be the same as the write operation—i.e. the samples are read out at equally spaced time intervals throughout the readout period and passed, sequentially and one at a time, to the output terminal 3 via the source follower MIR. However, other options are possible. For example, the contents of multiple cells could be read out simultaneously, and some analogue operation such as summing or averaging carried out on them before passing the resultant to the output terminal 3 via the source follower MIR.

Further, the timing diagrams In FIGS. 9 and 10 show the write operations and read operations taking approximately the same time. This need not necessarily be the case and, indeed, it is likely that the read operation will take longer, possibly a lot longer.

There are various ways in which the timing for the whole array of pixels can be arranged. For example, the write operation may be synchronous, meaning that all pixels are written to at the same time. By contrast, reading may be done in much the same way as in a standard CMOS sensor, i.e. row by row. During reading the input amplifier MB1, MIN is OFF (signals reset_w and write low). The signals reset-r and read are common to all the pixels in a row, but are different from row to row since all the pixels in a column share a common output load. In this way, all the samples in a row are read in parallel.

The result of this method of operation is that there Is a substantial difference between the write period and the read period. For example, consider a sensor with N×N pixels, each with M samples. Let us also suppose that the time for writing a sample is T_{ws}, while the time for reading one row is Tᵣᵣ. The total write time T_{w}, i.e. the time needed to write all the memory cells, is then given by T_{ws}*M, since all the pixels are operating in parallel: T_{w}=T_{ws}*M. The time Tᵣ needed to read all the samples in the array is given by Tᵣ=Tᵣᵣ*N*M. Hence the duty cycle D will be:—

$$D = \frac{{T}_{ws} * M}{{T}_{rr} * N * M} = \frac{{T}_{ws}}{{T}_{rr} * N} \approx \frac{1}{N}$$

In the last equality it is assumed that T_{ws}≈Tᵣᵣ, which is at present quite a good assumption. This value of duty cycle has to be taken as a worst case. There are several ways of reducing the duty cycle, for example by interleaving read and write or by increasing the number of output nodes. In this latter case, the readout time will be reduced in direct proportion to the number of output nodes.

The technique of storing samples during the integration enables a number of different functions to be carried out, such as:

1) Noise reduction. The reset value vrst-w on the photodiode can be stored in one memory cell and the amplified sensor signal in the remainder. Differential readout gives a noise reduction. kTC and FPN noise in the first stage is then eliminated. kTC and FPN noise in the second stage can be eliminated by a second differential readout.

2) Dynamic range enhancement. By sampling the image with different integration periods, dynamic range enhancement can be achieved. It is also possible to contemplate an alternative first stage design with adjustable gain.

3) Speed. Sampling images at 1-10 MHz is possible. Speed can increase with time, as CMOS technology evolves.

Reference is now made to FIG. 7 which illustrates a single memory cell of the type used in the embodiment of FIG. 5. Each memory cell receives an input signal from the common line 4 via an input terminal 5, and a control signal sample <0> to sample <n> via a control terminal 6. The memory cell comprises a switch means in the form of an NMOS transistor T6 and a storage means in the form of capacitor C, this latter in practice being realised as a second NMOS transistor. The substrates of both transistors are connected to ground, as shown.

The control input is applied to the gate of the transistor T6 to thereby switch the transistor ON to thus connect the capacitor C to the input terminal 5 and hence to the common line 4. Thus, for the short period that the transistor T6 is switched on, a sample of the instantaneous voltage on line 4 is stored in capacitor C. After the transistor T6 is switched OFF, the capacitor C is effectively isolated, and thus retains its charge until subsequently being read out by the further application of a control signal to the control input 6 which once again switches the transistor T6 ON to connect the capacitor C to the common line 4.

The size of the capacitor C is important in determining the kTC noise. During the read operation, the charge stored in the capacitor is dumped onto the common line 4 which, during read, is the input to the output stage. The size of the capacitor is a factor in determining the gain of the output stage since charge sharing occurs. For both writing and reading it is desirable to have as large capacitors as possible to achieve lower noise (during writing) and higher gain (during reading).

A second embodiment of the invention will now be described with reference to FIG. 4 which is similar to FIG. 3 but in which the common amplifier A1 is replaced by multiple amplifiers, each located within a respective memory cell. The circuit is shown in greater detail in FIG. 6, which corresponds to FIG. 5 of the first embodiment. The primary difference between the two circuits is that, whereas in FIG. 5 some common circuitry is used for both the write and read operations, in FIG. 6, the write operation and the read operation are entirely separate. The amplified signal at the output of the inverter MB1, MIN is written to the memory cells M0 to M9 via the common line 4 in the same manner as described above. However, reading of the memory cells is carried out by separate circuitry primarily within the individual memory cells.

To achieve this each of the memory cells M0 to M9 has separate input and output connections 10,11 respectively. All of the input connections 10 are connected to the common line 4 and are used exclusively for the write operation. All of the output connections 11 are connected together and to a common output terminal 13 which is connected to the column bus via the pixel select transistor MSE and output terminal 3, as before.

In addition separate control inputs are provided for each memory cell: a write control input w and a read control input r. In the embodiment of FIG. 5, the write and read signals were applied via a common control input in each memory cell.

The write control signals w<0> to w<9> operate substantially as described above with reference to FIG. 5 (FIGS. 9C to 9E). The read control signals r<0> to r<9> operate In the same way as the read control signals of the FIG. 5 embodiment (FIGS. 10C to 10E), but the separation of the two functions enables greater flexibility to be obtained in the timing of the various operations.

The output source follower and read switch are not shown in FIG. 6. The reason for this is that these components are contained within the individual memory cells, as made clear in FIG. 8 to which reference will now be made.

FIG. 8 is a circuit diagram of a memory cell M0 to M9, as used in the embodiment of FIG. 6. As can be seen the left-hand part of the circuit is similar to that of FIG. 7, and the same reference numerals have been used where appropriate. The left-hand side of the circuit also operates in the same manner as described, except that the control input 6 in the circuit of FIG. 8 is only used for writing and therefore is more properly referred to as the write control input.

In an embodiment of FIGS. 6 and 8, the value held on each capacitor C in the memory cell may be read out and processed individually via an NMOS source follower transistor T10 and an NMOS select transistor T11. The transistors T10 and T11 are connected in series between the supply rail Vdd and the output terminal 11. A common current source (not shown) supplies current to energise the source follower when the select transistor T11 is switched ON. The gate of the select transistor T11 is connected to a read control input 12. The transistor T11 is switched ON by means of a suitable pulse signal at read control input 12 and this allows the voltage on the capacitor C to be read out via the source follower T10 and passed to the output terminal 11. During this time, the transistor T6 is preferably switched off, thus isolating the voltage on the capacitor C from the common line 4.

The operation of the embodiment of FIGS. 6 and 8 will be apparent from the above explanation, in conjunction with the description of the operation of the embodiment of FIGS. 5 and 7.

FIGS. 11 to 15 show modified versions of the embodiment of FIGS. 3/5. However, it will be understood by those skilled in the art that equivalent modifications could also be made to the embodiment of FIGS. 4/6.

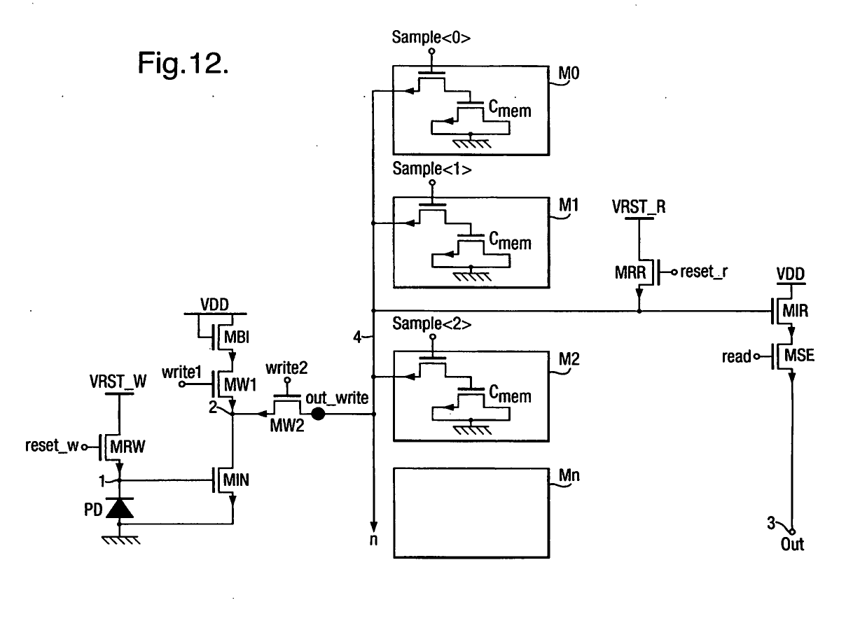

Referring to FIGS. 11 and 12, there are shown two modified input stages in which there are still two switching transistors MW1 and MW2 to control the writing function, but they are no longer connected In series between VDD and ground. Instead, the transistor MW2 is placed In the signal path between junction 2 and common line 4. The transistor MW1 remains in the path between VDD and ground but can be connected either below the junction 2 (FIG. 11) or above it (FIG. 12).

This alternative arrangement may help to increase the dynamic range and also to reduce the leakage current at the junction out_write since now only one of the switching transistors is connected to it. The signals to be applied to the gates of transistors MW1 and MW2 are indicated separately as write1 and write2 respectively. Although the gates could be driven by separate write signals, in practice it is likely that they will be connected together and driven by a single write signal, as with the previous embodiments.

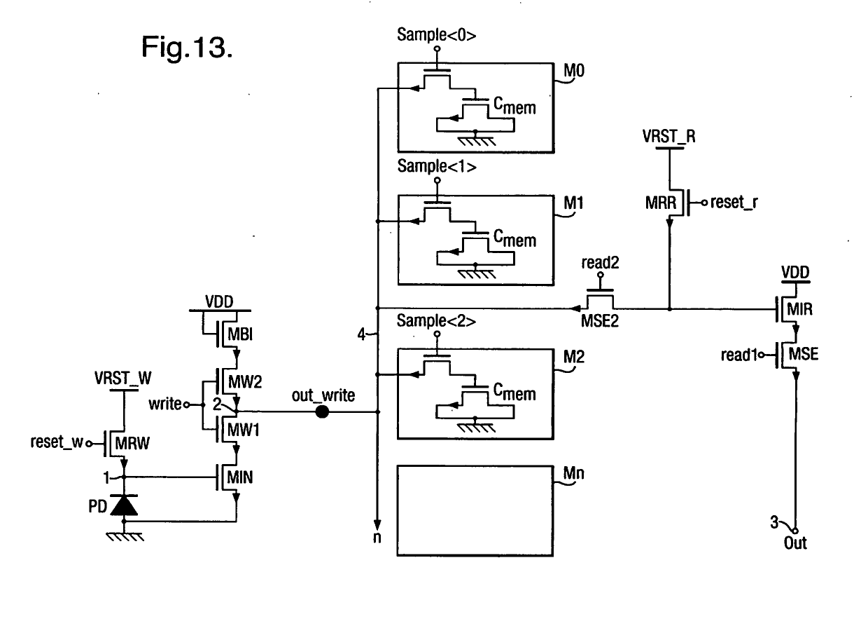

The embodiment of FIG. 13 adds a second read transistor MSE2 which is connected between the common line 4 and the original output stage comprising transistors MIR, MRR and MSE. The transistor MSE2 is controlled by a read signal read2 whilst the transistor MSE is controlled by a read signal read1.

The function of transistor MSE2 is to keep uniform the readout timing for all of the rows. In the absence of transistor MSE2, the reset effected by transistor MRR is only applied to all the rows at the beginning of the readout time. After that, a sample signal would be selected and then the stored charge would stay on the node out_write until the end of readout. This means that the time between the reset/sample transfer and the actual readout of the sample would depend on the row position, affecting the uniformity of the device. Again, signals read1 and read2 are marked as separate but could (and probably would) be connected to the same signal line.

It will be understood that the changes described with reference to FIGS. 11 to 13 in the write and read circuitry could be combined together in a modified version of FIG. 5.

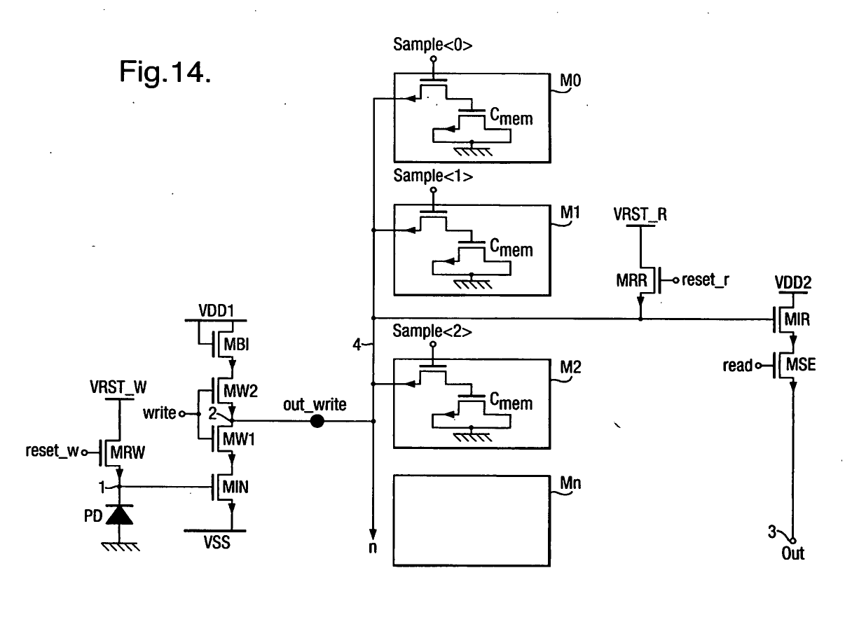

It is desirable to keep the power consumption in the writing stage as low as possible since all of the pixels are working in parallel during the writing phase. This is addressed in the circuit of FIG. 14 in which the two supply points VDD are separated into two, namely V_{DD1} and V_{DD2}. Also, instead of having the source of transistor MIN connected to ground, it could be connected to a different potential Vss that could be generated either externally, or internally, possibly within the pixel itself.

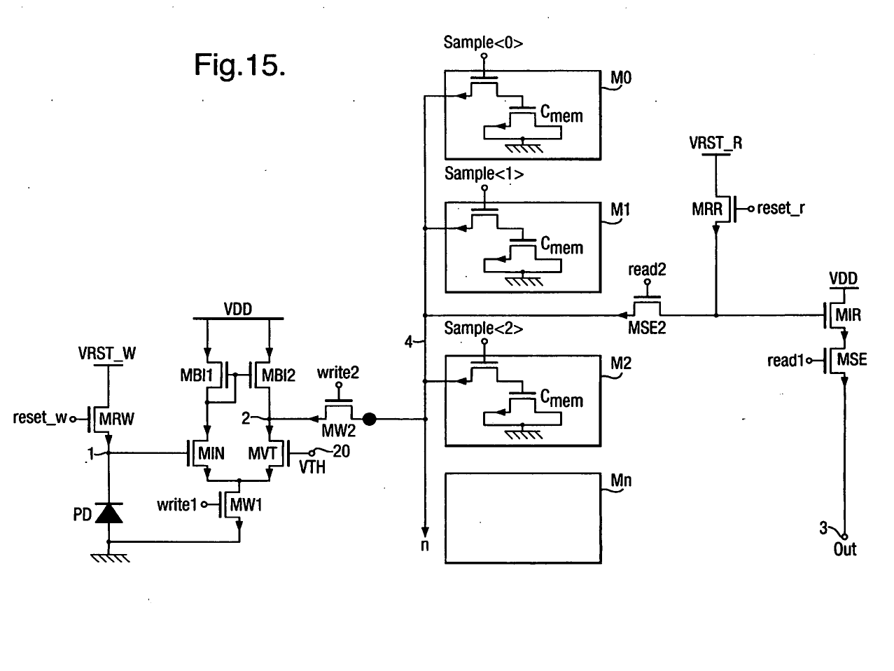

In the embodiment of FIG. 15 the single-ended write amplifier of the previous embodiments is replaced by a differential amplifier comprising four transistors MB11, MIN, MB12, MVT. The non-inverting input 20 is connected to a threshold signal V_{TH}. Thus the amplifier will only generate a positive step if the input signal exceeds the threshold level. The signal write1 would now be switching between ground and a voltage set by the requirement of power consumption (the transistor MW1 acts now like a current source instead of a simple switch as in the previously described embodiments). In this design, the signal stored in the capacitors Cmem would only be digital, but, depending on the exact way the signal VTH is used and the sample <n> signals are operated, the digital information could have different meaning. For example, in the simplest case, it would only contain hit no-hit information. If the threshold VTH is ramped, then a single ramp analogue-to-digital conversion (ADC) could be obtained, or the information relative to the time when the event occurs could be recorded.

As before, it will be understood that the ideas expressed in relation to the embodiments of FIGS. 14 and 15 could be combined with those of FIGS. 11 to 13 and, indeed, it will be noted that the circuit of FIG. 15 contains some of the features of FIGS. 11 and 12.

The various imaging devices described above have a number of advantages over CCD imagers, or devices using standard APS architecture. Some of these advantages may be listed as follows:

Flexibility in readout schemes: for example, readout can be delayed with respect to the actual data taken; this can be particularly useful in applications where short, fast events have to be acquired and can then be read in a second subsequent phase.

Flexibility in writing: the timing of the writing process in each pixel can be driven by the user so that its memory cells can store the image at a chosen time.

Speed: because of the use of local storage on the pixel, frame speeds in excess of 1 MHz are possible.

Noise: differential readout allows a reduction of reset noise (also known as kTC noise) and Fixed Pattern Noise (FPN); amplification can be used to further reduce the kTC noise.

Redundancy: the local storage area is random access; pixel failures can be corrected by using adjacent memory cells, as described above; this can be particularly relevant for very large area devices, where the pixel count is very high.

Dynamic range: sampling the same scene with different readout times can enhance intrascene dynamic range. Also, the total pixel gain can be adjusted in between different snapshots, in order to provide low gain for bright images and high gain and better noise performances for low light levels. Single photon detection could become possible by accurately selecting gain and noise performance.

The operation of the imaging devices described herein results in a sort of 3-D imaging, where a third dimension (time) is added to the normal 2-D imaging. This is a result of the local storage of images in memory, enabling the write and read operations to be split into two phases.

Other advantages of the imaging devices described above which are not only peculiar to the present invention but are more typical of any CMOS sensors are the low power consumption and the scalability following shrinking in the minimal dimension of CMOS electronics. The described devices will also profit from the Integration of a detection layer (i.e. amorphous silicon) on top of the pixel in order to enhance the fill factor and hence the quantum efficiency of the sensor.

The proposed imaging device can be compared with two existing technologies: standard CMOS APS and ultrafast cameras (streak or framing):

Standard CMOS APS

The proposed imaging device uses standard CMOS technology. It adds more functionality to the standard sensor by integrating memory cells and continuously biased amplifiers Inside the cell. The advantages of the proposed imaging device are in terms of:—

Speed:> 1 Mfps (frames per second). Current top-end sensors are PB-MV from Photobit/MicronImaging, 4 MP at 240 fps, and Lupa, 1.3 Mpixels at 450 fps from FillFactory. Their limitation in speed comes from the fact that all the data needs to be read out before another image is taken. By storing locally in the pixel, this limitation is removed.

Flexibility: it is possible to perform analogue operations on data before reading it out. This can be also used to enhance the dynamic range and reduce noise.

Streak and Framing Cameras

These are very specialised technologies for very fast recording of a few frames. The advantages over this type of product are in terms of:

Low cost: because the proposed Imaging device is fabricated with CMOS technology, it is possible to integrate many system functions on the chip itself.

Low power: as above, this is given by the use of CMOS technology.

Portability/Miniaturisation: the proposed device could lead to a portable solution (<<1 kg) whereas at present streak cameras are heavy and bulky.

Ease of use: signal control can be integrated in the chip itself.

Length of data storage: most streak cameras can record up to about 16 frames while some cameras can go up to 64, but with reduced time resolution. Table 2 (above) shows an estimated scaling of the proposed device. Table 2 is equivalent to Table 1 but with a technology foreseen in about 10 years' time. By then, component dimensions will be reduced by a factor of 10. For the same capacitance value, it would become possible to integrate 1000 cells in a pixel of 40×40 μm.

Applications for the invention include general imaging applications for the imaging of electromagnetic radiation, electric potentials or charged particle radiation. In addition, with the use of a converter, neutron detection could also be achieved. There follows a selection of possible specific applications, although many more will be evident to those skilled In the art:

Visible light imaging of: wide dynamic range phenomena, fast phenomena (to be captured at over 10⁶ fps).

Detection of charged particles: depending on the type of sensor integrated in the circuit, the area underneath the electronics can be made sensitive to charged particles achieving 100% efficiency. Applications: vertex or tracking detectors in particle physics, or beta autoradiography in biomedicine.

Detection of X-rays: the proposed device will be useful in large area detectors for radiography since the two stage architecture will allow longer readout times without degrading the performance of the sensor. It also allows the direction of readout to be changed. It could be possible to realise large area sensors in a modular, more cost-effective way.

1. An imaging device comprising an array of pixels in which, for each pixel, there is provided: a sensor which is sensitive to a variable quantity to be imaged and for outputting a signal representative of the variation in said quantity during an integration period; amplifier means for amplifying the signal from said sensor; a plurality of memory cells for holding sequential samples of the amplified signal from the sensor during the integration period; and read switch means actuable to enable the contents of said memory cells to be read out.

2. An imaging device as claimed in claim 1 wherein the sensor, amplifier means, memory cells and read switch means are located within the circuitry of each pixel.

3. An imaging device as claimed in claim 1 wherein each memory cell comprises a selection means and a storage means.

4. An imaging device as claimed in claim 3 wherein said selection means is actuated to select that memory cell by a control signal from a common timing circuit.

5. An imaging device as claimed in claim 4 wherein said timing circuit is such that, during each integration period, at least one memory cell at a time is selected in succession and a sample representative of the instantaneous value of the amplified output signal from the sensor is written to the storage means of the selected memory cell.

6. An imaging device as claimed in claim 5 wherein the timing circuit acts to write samples throughout the integration period, there being a sufficient number of memory cells that each cell stores a single sample.

7. An imaging circuit as claimed in claim 6 wherein the samples are arranged at evenly spaced time intervals throughout the integration period.

8. An imaging device as claimed in claim 1 further comprising write switch means operable to connect the output signal from said sensor to the memory cells via said amplifier means.

9. An imaging device as claimed in claim 8 wherein said write switch means is operable to energise and de-energise said amplifier means to thereby selectively allow the passage of the output signal of said sensor through the amplifier means to the memory cells.

10. An imaging device as claimed in claim 9 wherein said write switch means comprises a first switch means operable to energise and de-energise said amplifier means as aforsaid, and a second switch means located in the signal path from the output of said amplifier means, and wherein said first and second switch means may or may not be actuated in common.

11. An imaging device as claimed in claim 3 wherein said timing circuit is further operable, during a read period corresponding with the actuation of said read switch means, to successively read the samples stored within the memory cells.

12. An imaging device as claimed in claim 11 wherein the memory cells are read out on a one-by-one basis.

13. An imaging device as claimed in claim 11 wherein multiple memory cells are read out simultaneously and means are provided for carrying out an analogue operation on the simultaneously read out samples and outputting a resultant signal.

14. An imaging device as claimed in claim 11 wherein said timing circuit is such as to separate the read period from the integration period, so that they do not overlap.

15. An imaging device as claimed in claim 11 wherein said timing circuit is such as to overlap the read period and the integration period, and wherein the operations of writing into the individual memory cells and reading from the individual memory cells are time interleaved with one another.

16. An imaging device as claimed in claim 11 further comprising read reset means for resetting the circuit prior to the commencement of each read period.

17. An imaging device as claimed in claim 16 wherein said reset means is operable to reset the circuit between each reading of a sample stored within a respective memory means.

18. An imaging device as claimed in claim 11 wherein said read switch means includes a single select switch for sequentially passing the contents of the storage means within respective memory cells, as they are read out, to an output connected to a column bus.

19. An imaging device as claimed in claim 11 wherein said read switch means comprises a select switch located within each memory cell, wherein said timing means is such as to actuate said select switches to thereby select the memory cells for reading out, and wherein the outputs of said select switches are passed to a common output which is connected to a column bus.

20. An imaging device as claimed in claim 16 wherein said read switch means comprises two select switches, one located between the storage means and the read reset means, and one located between the read reset means and an output connected to a column bus.

21. An imaging device as claimed in claim 1 wherein said variable quantity is electromagnetic radiation.

22. An imaging device as claimed in claim 21 in which the radiation is visible light.

23. An imaging device as claimed in claim 1 wherein said sensor is sensitive to charged particles.

24. An imaging device as claimed in claim 1 wherein said variable quantity is neutron radiation.

25. An imaging device as claimed in claim 1 wherein said variable quantity is a voltage.

26. An imaging device as claimed in claim 1 wherein said amplifier means comprises a MOS transistor connected as a source follower.

27. An imaging device as claimed in claim 1 wherein said amplifier means is an inverter comprising a pair of MOS transistors.

28. An imaging device as claimed in claim 1 wherein said amplifier means comprises a charge amplifier.

29. An imaging device as claimed in claim 1 wherein said amplifier means comprises a differential amplifier having inverting and non-inverting inputs.

30. An imaging device as claimed in claim 29 wherein the output from the sensor is connected to one of said inputs, and a threshold signal is connected to the other of said inputs, the arrangement being such that the amplifier means generates an output only if the input signal exceeds a certain threshold level.

31. An imaging device as claimed in claim 1 including a further amplifier means for amplifying the signal read out from said memory cells.

32-34. (canceled)

35. An imaging device as claimed in claim 39 wherein said or each amplifier is constituted by a MOS transistor connected as a source follower.

36. An imaging device as claimed in claim 39 wherein said or each amplifier comprises a charge amplifier.

37. An imaging device as claimed in claim 1 wherein said amplifier means is continuously energised during the integration period.

38. An imaging device as claimed in claim 2 including a further amplifier means for amplifying the signal read out from said memory cells, and wherein said further amplifier means is located within the circuitry of each pixel.

39. An imaging device as claimed in claim 18 including a further amplifier means for amplifying the signal read out from said memory cells, and wherein said further amplifier means comprises a single amplifier common to all of said memory cells.

40. An imaging device as claimed in claim 19 including a further amplifier means for amplifying the signal read out from said memory cells, and wherein said further amplifier means comprises an amplifier located within each memory cell.
